(19) United States
(12) Patent Application Publication
(10) Pub. No.: US 2015/0228966 A1
(43) Pub. Date: Aug. 13, 2015

(54) POSITIVE ELECTRODE MATERIAL, SECONDARY BATTERY, AND METHODS RESPECTIVELY FOR PRODUCING POSITIVE ELECTRODE MATERIAL AND SECONDARY BATTERY

(71) Applicant: Murata Manufacturing Co., Ltd., Nagaokakyo-shi (JP)

(72) Inventor: YUJI KINTAKA, Nagaokakyo-shi (JP)

(21) Appl. No.: 14/690,793

(22) Filed: Apr. 20, 2015

(30) Foreign Application Priority Data
Nov. 7, 2012 (JP) 2012-245529

(51) Int. Cl. H01M 4/36; H01M 4/136; H01M 4/62; H01M 4/04; H01M 4/58; H01M 10/0562; H01M 4/1397

(52) U.S. Cl. CPC H01M 4/362; H01M 10/0562; H01M 4/136; H01M 4/1397; H01M 4/0471; H01M 4/0433; H01M 4/5825; H01M 4/625; H01M 2300/0068; H01M 2004/028

(57) ABSTRACT

A positive electrode material that contains a positive electrode active material and fibrous carbon. The fibrous carbon is bound to the positive electrode active material. An all-solid-state battery that includes a positive electrode layer containing the positive electrode material, a negative electrode layer and a solid electrolyte layer interposed between the positive electrode layer and the negative electrode layer.

### CROSS REFERENCE TO RELATED APPLICATIONS

The present application is a continuation of International application No. PCT/JP2013/079674, filed Nov. 1, 2013, which claims priority to Japanese Patent Application No. 2012-245529, filed Nov. 7, 2012, the entire contents of each of which are incorporated herein by reference.

### FIELD OF THE INVENTION

The present invention relates to a positive electrode material, a secondary battery, and methods respectively for producing the positive electrode material and the secondary battery, specifically relates to a positive electrode material, a secondary battery such as an all-solid-state battery which utilizes a sulfide solid electrolyte, and methods respectively for producing the positive electrode material and the secondary battery.

### BACKGROUND OF THE INVENTION

In recent years, secondary batteries have been increasingly demanded as cordless power supplies for mobile electronic devices such as mobile phones and note-type personal computers in association with the development of these electronic devices. Particularly, chargeable and dischargeable lithium ion secondary batteries each having a high energy density have been developed aggressively.

In a lithium ion secondary battery, a solution produced by dissolving, in an organic solvent, a metal oxide such as lithium cobaltate which serves as a positive electrode active material, a carbon material such as graphite which serves as a negative electrode active material, and lithium hexafluorophosphate which serves as an electrolyte, i.e., an organic solvent-type electrolytic solution, has been used generally. In a battery having this constitution, it is attempted to increase an internal energy, further increase an energy density and improve an output current by increasing the amounts of active materials. Furthermore, it has also been demanded to increase the size of the battery and to install the battery into a vehicle safely.

However, in a lithium ion secondary battery having a structure as mentioned above, an organic solvent which is used in an electrolyte is a flammable substance and therefore the battery has the risk of ignition. Therefore, it has been demanded to further improve the safety of the battery.

As one measure for improving the safety of a lithium ion secondary battery, the use of a solid electrolyte instead of an organic solvent-type electrolytic solution has been considered. As the solid electrolyte, the use of an organic material (e.g., a polymer and a gel) or an inorganic material (e.g., glass and ceramic) has been considered. Particularly, an all-solid-state secondary battery in which an inorganic material mainly composed of inflammable glass or ceramic is used as a solid electrolyte has been attracting attention.

For example, JP 2011-28893 A (referred to as “Patent Document 1” hereinbelow) discloses the constitution of an all-solid-state battery utilizing a sulfide solid electrolyte. In Patent Document 1, it is described that the electrical conductivity of a positive electrode active material layer (a positive electrode layer) can be improved by adding a conductivity-imparting material (i.e., a conductive additive) such as acethylene black, ketjen black and carbon fiber to the positive electrode active material layer.

Patent Document 1: JP 2011-28893 A

### SUMMARY OF THE INVENTION

However, when a conductive additive such as carbon fiber is added to and mixed with a solid electrolyte and a positive electrode active material as described in Patent Document 1, since the conductive additive can aggregate easily, the conductive additive cannot be dispersed in a positive electrode layer and aggregates of the conductive additive can be formed. When the conductive additive aggregates in the positive electrode layer, such a function of the conductive additive that the conductive additive can supply electrons to a positive electrode active material is deteriorated. That is, electron supply paths in the positive electrode layer are blocked and therefore good battery properties cannot be achieved.

In addition, it is possible to pulverize a mixture of the solid electrolyte, the positive electrode active material and the conductive additive strongly using a ball mill or the like for the purpose of dispersing the conductive additive in the positive electrode material. In this case, although the conductive additive can be dispersed in the positive electrode material, the solid electrolyte may also be pulverized. Therefore, lithium ion supply paths are disconnected, and consequently good battery properties cannot be achieved.

Then, an object of the present invention is to provide a positive electrode material which enables the improvement in battery properties, a secondary battery, and methods respectively for producing the positive electrode material and the secondary battery.

The present inventors have made studies on various constitutions of a positive electrode material containing a positive electrode active material. As a result, the present inventors have found that, when fibrous carbon is bound to a positive electrode active material, lithium ion supply paths can be secured in a positive electrode layer and electrons can be supplied to the positive electrode active material satisfactorily, in other words, electron supply paths can be secured in the positive electrode layer. The positive electrode material, the secondary battery and the methods respectively for producing the positive electrode material and the secondary battery according to the present invention, which are developed on the basis of the finding, have the following features.

The positive electrode material according to the present invention contains a positive electrode active material and fibrous carbon. The fibrous carbon is bound to the positive electrode active material.

In the positive electrode material according to the present invention, it is preferred that the positive electrode active material contains a lithium composite oxide having a polyanion structure represented by general formula: LiₐMₘXO_{b}F_{c} (wherein M represents at least one transition metal; X represents at least one element selected from the group consisting of B, Al, Si, P, Cl, Ti, V, Cr, Mo and W; and a, m, b and c represent numerical values respectively falling within the ranges represented by the formulae 0<a≦3, 0<m≦2, 2≦b≦4 and 0≦c≦1).

It is preferred that the lithium composite oxide is a phosphate compound.

It is preferred that the phosphate compound is lithium iron phosphate.

The secondary battery according to the present invention includes a positive electrode layer containing the above-mentioned positive electrode material, a negative electrode layer, and an electrolyte layer interposed between the positive electrode layer and the negative electrode layer.

In the secondary battery according to the present invention, it is preferred that the positive electrolyte layer contains a solid electrolyte, and the secondary battery is an all-solid-state battery.

It is preferred that the solid electrolyte is a sulfide solid electrolyte.

The method for producing a positive electrode material according to the present invention is a method for producing the above-mentioned positive electrode material, and includes the following steps:

(A) a step of mixing the positive electrode active material with the fibrous carbon to produce a mixture; and

(B) a step of heating the mixture.

The method for producing a secondary battery according to the present invention is a method for producing the above-mentioned secondary battery, wherein the positive electrode layer contains a solid electrolyte, the secondary battery is an all-solid-state battery, and the solid electrolyte is a sulfide solid electrolyte. The method includes the steps of:

(C) a step of mixing the positive electrode active material with the fibrous carbon to produce a first mixture;

(D) a step of heating the first mixture;

(E) a step of mixing the first mixture with the solid electrolyte to produce a second mixture; and

(F) a step of producing a molded article from the second mixture.

It is preferred that the method for producing a secondary battery according to the present invention further includes the steps of:

(G) a step of heating the molded article;

(H) a step of pulverizing the heated molded article to produce a pulverized material; and

(I) a step of producing a molded article from the pulverized material.

According to the present invention, in a positive electrode material containing a positive electrode active material, fibrous carbon is bound to the positive electrode active material, and therefore lithium ion paths can be secured in a positive electrode layer and electrons can be supplied to the positive electrode active material satisfactorily. This constitution enables the improvement in charge-discharge properties of a secondary battery, such as an all-solid-state battery, which utilizes a sulfide solid electrolyte.

### BRIEF EXPLANATION OF THE DRAWINGS

FIG. 1 is a cross-sectional view which schematically illustrates a cross-sectional structure of a battery element of an all-solid-state battery as an embodiment according to the present invention.

FIG. 2 is a perspective view which schematically illustrates a battery element of an all-solid-state battery as an embodiment according to the present invention.

FIG. 3 is a perspective view which schematically illustrates a battery element of an all-solid-state battery as another embodiment according to the present invention.

FIG. 4 is a photograph of composite particles each composed of a positive electrode active material and fibrous carbon, which are produced in the example of the present invention, observed on a scanning electron microscope (at a high magnification).

FIG. 5 is a photograph of composite particles each composed of a positive electrode active material and fibrous carbon, which are produced in the example of the present invention, observed on a scanning electron microscope (at a low magnification).

FIG. 6 is a photograph of composite particles each composed of a positive electrode active material and fibrous carbon, which are produced in the example of the present invention, observed on a scanning electron microscope (at a medium magnification).

FIG. 7 is a diagram illustrating a charge-discharge curve of an all-solid-state battery produced in the example of the present invention.

FIG. 8 is a diagram illustrating a charge-discharge curve of an all-solid-state battery produced in the comparative example of the present invention.

### DETAILED DESCRIPTION OF THE INVENTION

Hereinbelow, embodiments of the present invention will be described with reference to the drawings.

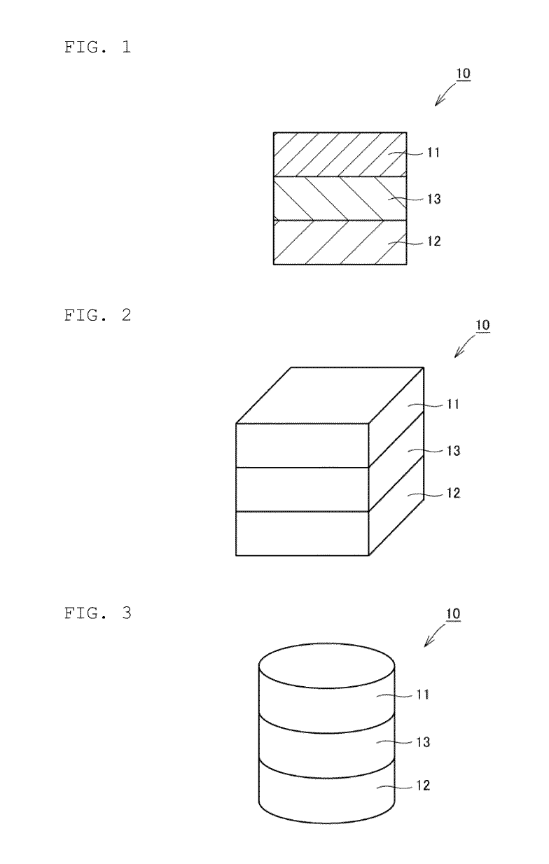

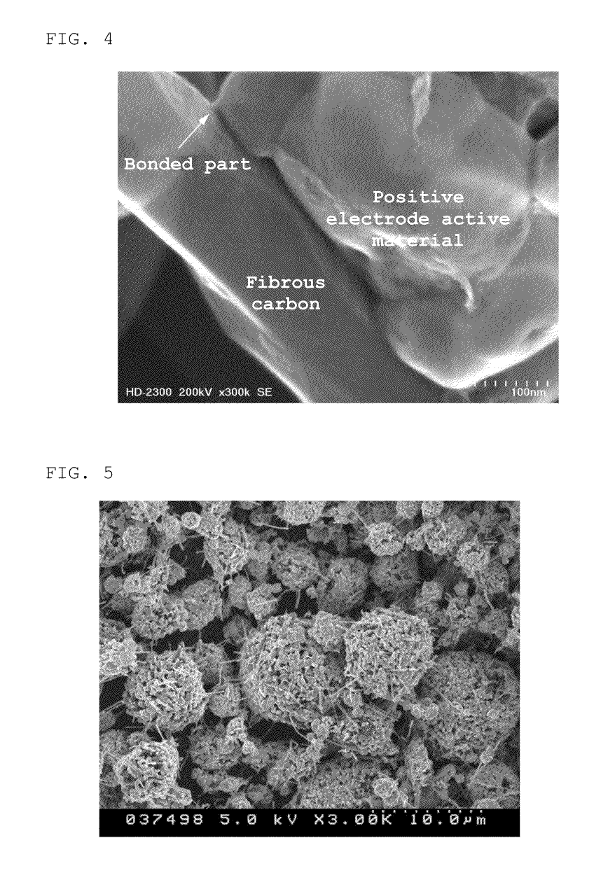

As illustrated in FIG. 1, an all-solid-state battery 10 according to the present invention includes a positive electrode layer 11, a negative electrode layer 12 and a solid electrolyte layer 13 interposed between the positive electrode layer 11 and the negative electrode layer 12. As illustrated in FIG. 2, as one embodiment of the present invention, the all-solid-state battery 10 is formed in a rectangular parallelepiped shape and is composed of a laminate of a plurality of flat-plate-shaped layers each having a rectangular flat surface. As illustrated in FIG. 3, as another embodiment of the present invention, the all-solid-state battery 10 is formed in a cylindrical shape and is composed of a laminate of a plurality of disc-shaped layers. Each of the positive electrode layer 11 and the negative electrode layer 12 contains a sulfide solid electrolyte and an electrode active material, and the solid electrolyte layer 13 contains a sulfide solid electrolyte.

In the all-solid-state battery 10 according to the present invention which is configured as mentioned above, the positive electrode material that constitutes the positive electrode layer 11 contains a positive electrode active material and fibrous carbon. The fibrous carbon is bound to the positive electrode active material.

In the positive electrode layer 11 containing the positive electrode active material, since the fibrous carbon is bound to the positive electrode active material, lithium ion paths can be secured in the positive electrode layer 11 and electrons can be supplied to the positive electrode active material satisfactorily. As a result, the charge-discharge properties of the all-solid-state battery 10 can be improved.

It is preferred that the positive electrode active material contains a lithium composite oxide having a polyanion structure represented by general formula LiₐMₘXO_{b}F_{c} (wherein M represents at least one transition metal; X represents at least one element selected from the group consisting of B, Al, Si, P, Cl, Ti, V, Cr, Mo and W; and a, m, b and c represent numerical values respectively falling within the ranges represented by the formulae 0<a≦3, 0<m≦2, 2≦b≦4 and 0≦c≦1).

The lithium composite oxide is preferably a phosphate compound, and the phosphate compound is preferably lithium iron phosphate.

The above-mentioned constitutions, functions and effects of the present invention are based on the following considerations and findings by the present inventors.

In an all-solid-state battery, an electrolyte that supplies lithium ions has a solid form, and therefore, it is required to form electron supply paths and lithium ion supply paths by mixing a positive electrode active material (a solid form) with a solid electrolyte. However, a solid electrolyte is an electron-insulating material, and therefore the solid electrolyte that penetrates into the positive electrode active material can interfere with the conduction of electrons. Therefore, it is considered that the electron conductivity of the positive electrode layer can be improved by adding an electrically conductive substance to a mixture of the solid electrolyte and the positive electrode active material. However, when only the addition of an electrically conductive substance such as carbon is performed, the positive electrode active material and the electrically conductive substance are separated from each other and therefore it is impossible to form electron supply paths for highly efficiently supplying electrons to the positive electrode active material. Further, even when an electrically conductive substance is adhered onto the surface of the positive electrode active material, the solid electrolyte penetrates between the electrically conductive substance and the positive electrode active material and therefore electron supply paths cannot be formed. Particularly when a positive electrode active material having low electron conductivity, such as a lithium phosphate compound having an olivine-type structure, is used, it is difficult to secure electron supply paths in the positive electrode layer.

On the other hand, when a fibrous electrically conductive substance is used, electron supply paths can be formed in the positive electrode active material relatively easily. However, when a fibrous electrically conductive substance is added to and mixed with a solid electrolyte and a positive electrode active material, the fibrous electrically conductive substance is likely to aggregate during the mixing. If the electrically conductive substance aggregates in the positive electrode layer, electron supply paths in the positive electrode layer are interfered.

Then, the present inventors have found that, when fibrous carbon is bound to a positive electrode active material, lithium ion supply paths can be secured in a positive electrode layer and electrons can be supplied to the positive electrode active material satisfactorily, in other words, electron supply paths can be secured in the positive electrode layer.

When the fibrous carbon is bound to the positive electrode active material, the following effects can be achieved: when the positive electrode active material, the sulfide solid electrolyte and the fibrous carbon are mixed together, since the fibrous carbon which is an electrically conductive substance is bound to the positive electrode active material, electron supply paths can be secured in the positive electrode active material; when the positive electrode active material, the sulfide solid electrolyte and the fibrous carbon are mixed together, the sulfide solid electrolyte cannot penetrate between the positive electrode active material and the fibrous carbon due to the strong bonding of the positive electrode active material to the fibrous carbon, and the electrical bonding of the positive electrode active material to the fibrous carbon can be retained in a good condition even after the mixing; when the positive electrode active material, the sulfide solid electrolyte and the fibrous carbon are mixed together, the fibrous carbon can be retained in a dispersed state and therefore does not aggregate; and when composite particles produced by fusing the positive electrode active material and the fibrous carbon to each other are used, the migration of electrons between the positive electrode active material and the fibrous carbon that is an electrically conductive substance is improved and therefore the supply of electrons to the positive electrode active material is also improved.

With respect to the state of the binding of the fibrous carbon to the positive electrode active material, it is preferred to use secondary particles (complex granules) each composed of a complex of the positive electrode active material and the fibrous carbon. In this case, the positive electrode active material has a partially aggregated state in the positive electrode layer, the supply of electrons to the positive electrode active material can be improved, and therefore the battery properties can be further improved. It is more preferred to use secondary particles composed of complex granules of the sulfide solid electrolyte, the positive electrode active material and the fibrous carbon which have an average particle diameter of 10 μm or more. In this case, both of the supply of lithium ions and the supply of electrons to the positive electrode active material can be improved, and therefore the battery properties can be further improved. It is still further preferred that a complex of the sulfide solid electrolyte, the positive electrode active material and the fibrous carbon is agitated, then molded, and then heated. In this case, the adhesion between the positive electrode active material and the sulfide solid electrolyte can be improved, and therefore the supply of lithium ions to the positive electrode active material can be further improved.

As mentioned above, by optimizing the state of the bonding of the fibrous carbon to the positive electrode active material, both of electron supply paths and lithium ion supply paths to the positive electrode active material can be formed satisfactorily, almost the whole of the positive electrode active material contained in the positive electrode layer can become active, and consequently it becomes possible to produce a battery having a rate of utilization of the positive electrode active material of more than 90%.

The above-mentioned functions and effects can be achieved in an all-solid-state battery utilizing the above-mentioned sulfide solid electrolyte as well as an all-solid-state battery produced by firing using an oxide solid electrolyte, and can also be achieved in a non-aqueous electrolyte secondary battery utilizing an organic solvent-type electrolytic solution, as long as a positive electrode material contains at least a positive electrode active material and fibrous carbon and the fibrous carbon is bound to the positive electrode active material in the positive electrode material. That is, the constitution of the positive electrode material according to the present invention can be applied to all-solid-state batteries as well as a wide variety of secondary batteries.

Examples of the lithium composite oxide having a polyanion structure, which is a positive electrode active material constituting the positive electrode layer 11 in the all-solid-state battery 10 according to the present invention include LiFePO₄, LiCoPO₄, LiFe_{0.5}Co_{0.5}PO₄, LiMnPO₄, LiCrPO₄, LiFeVO₄, LiFeSiO₄, LiTiPO₄, LiFeBO₃, Li₃Fe PO₄, LiFe_{0.9}Al_{0.1}PO₄ and LiFePO_{3.9}F_{0.1}. For the purpose of improving the electron conductivity of the positive electrode active material, some of the elements in the above-mentioned positive electrode active materials may be substituted with other elements, or the surface of the lithium composite oxide may be coated with an electrically conductive substance such as carbon, or an electrically conductive substance may be encapsulated in particles of the positive electrode active material. These means do not inhibit the effect of the present invention and can be used suitably, and the employment of these means are also included within the scope of the present invention. The compositional ratio of elements that constitute the positive electrode active material is not limited to the above-mentioned ratios and may be deviated from the stoichiometric range.

The negative electrode layer 12 contains a negative electrode active material and a sulfide solid electrolyte. As the negative electrode active material, a carbon material such as graphite and hard carbon, an alloy-type material, sulfur, a metal sulfide or the like can be used.

The solid electrolyte layer 13 which is interposed between the positive electrode layer 11 and the negative electrode layer 12 contains a sulfide solid electrolyte.

The solid electrolyte to be contained in the positive electrode layer 11, the negative electrode layer 12 and the solid electrolyte layer 13 may be any one, as long as the solid electrolyte contains an ion-conducting compound, and may also be any one as long as the solid electrolyte contains at least lithium and sulfur as constituent elements. Examples of the compound include a mixture of Li₂S and P₂S₅ and a mixture of Li₂S and B₂S₃. It is preferred that the solid electrolyte contains phosphorus as a constituent element in addition to lithium and sulfur, and examples of the compound include a mixture of Li₂S and P₂S₅, Li₇P₃S₁₁ and Li₃PS₄. In these compounds, some of anions may be substituted with oxygen. Among the above-mentioned compounds, glass and a glass ceramic material each containing no bridging S atom and having a nominal composition of 80Li₂S-20P₂S₅ or the like and Thio-LISICON are preferred. The compositional ratio of elements that constitute the solid electrolyte is not limited to those mentioned above.

The all-solid-state battery 10 according to the present invention may be used in such a form that a battery element as illustrated in any one of FIG. 1 to FIG. 3 is placed in a ceramic container, or may be used in the form as illustrated in any one of FIG. 1 to FIG. 3 as a self-support-type battery.

The method for armoring the battery is also not limited particularly, and a metallic case, a mold resin, an aluminum laminate film and the like may be used.

In the method for producing the positive electrode material according to the present invention, the positive electrode active material is mixed with the fibrous carbon to produce a mixture, and then the mixture is heated.

In the method for producing the all-solid-state battery 10 according to the present invention, the positive electrode active material is mixed with the fibrous carbon to produce a first mixture, the first mixture is heated, the first mixture is mixed with the solid electrolyte to produce a second mixture, and a molded article is produced from the second mixture.

In the method for producing the all-solid-state battery 10 according to the present invention, it is preferred that the molded article is heated, then the heated molded article is pulverized to produce a pulverized material, and then a molded article is produced from the pulverized material. In this case, both electron supply paths and lithium ion supply paths to the positive electrode active material can be formed satisfactorily, and consequently battery properties can be improved further.

In the method for producing the all-solid-state battery 10 according to the present invention, each of the positive electrode layer 11, the negative electrode layer 12 and the solid electrolyte layer 13 can be produced by the compression molding of a raw material thereof. In this case, the positive electrode layer 11 is produced by producing a molded article by the compression molding of the positive electrode material that is produced in the above-mentioned manner. Alternatively, the positive electrode layer 11 is produced by heating the above-mentioned molded article, then pulverizing the heated molded article to produce a pulverized material, and then compression-molding the pulverized material. Each of the negative electrode layer 12 and the solid electrolyte layer 13 is produced by compression-molding a raw material thereof. Subsequently, the positive electrode layer 11 and the negative electrode layer 12 are laminated with the solid electrolyte layer 13 interposed therebetween, whereby a laminate can be produced.

Alternatively, each of the positive electrode layer 11, the negative electrode layer 12 and the solid electrolyte layer 13 can be produced by producing a solid-liquid mixture, such as a slurry, a paste or a colloid, which contains a raw material of the layer. In this case, firstly solid-liquid mixtures respectively containing raw materials of the positive electrode layer 11, the negative electrode layer 12 and the solid electrolyte layer 13 are produced (a solid-liquid mixture production step). Subsequently, molded articles, such as sheets, printed layers and films are produced respectively using the solid-liquid mixtures. The molded articles are laminated on one another, thereby producing a laminate (a laminate production step). The laminate may be sealed in, for example, a coin cell. The method for the sealing is not particularly limited. For example, the laminate may be sealed with a resin. Alternatively, the laminate may be sealed by applying an insulating material paste having an insulating property, such as Al₂O₃, to the surroundings of the laminate or dipping the laminate in the insulating material paste and then thermally treating the insulating material paste.

For the purpose of drawing an electric current from the positive electrode layer 11 and the negative electrode layer 12 with high efficiency, a current collector layer such as a carbon layer, a metal layer and an oxide layer may be formed on each of the positive electrode layer 11 and the negative electrode layer 12. An example of the method for forming the current collector layer is a sputtering method. Alternatively, a metal paste may be applied onto each of the positive electrode layer 11 and the negative electrode layer 12 or dipping each of the positive electrode layer 11 and the negative electrode layer 12 in a metal paste, followed by a thermal treatment of the metal paste. Alternatively, a carbon sheet may be laminated on each of the positive electrode layer 11 and the negative electrode layer 12.

In the laminate production step, it is preferred to form a single cell structure by laminating the positive electrode layer 11, the solid electrolyte layer 13 and the negative electrode layer 12 on one another. Furthermore, in the laminate production step, a plurality of laminates each having the above-mentioned single cell structure may be laminated on each other with a current collector interposed therebetween to form another laminate. In this case, the plurality of laminates each having the single cell structure may be electrically laminated in series or in parallel.

The method for producing each of the layers is not particularly limited. A doctor blade method, a die coater method, a comma coater method or the like may be employed for forming each of the layers in a sheet-like form, and a screen printing method or the like may be employed for forming each of the layers in the form of a printed layer or a film. The method for laminating the layers is not particularly limited. The lamination may be carried out employing a hot isostatic pressing method, a cold isostatic pressing method, an isostatic pressing method or the like.

The slurry can be produced by the wet mixing of an organic vehicle, which is prepared by dissolving an organic material in a solvent, with (the positive electrode active material and the solid electrolyte, the negative electrode active material and the solid electrolyte, or the solid electrolyte alone). In the wet mixing, a medium may be used. Specifically, a ball mill method, a viscomill method or the like may be employed. Alternatively, a wet mixing method using no medium may be employed, and a sand mill method, a high-pressure homogenizer method, a kneader dispersion method or the like may be employed. The organic material to be contained in the slurry is not particularly limited, and an acrylic resin or the like which cannot react with a sulfide can be used. The slurry may contain a plasticizer.

Next, an example of the present invention will be described concretely. However, the example mentioned below is intended to illustrate the invention and is not to be construed to limit the scope of the invention.

### Examples

Hereinbelow, an example and a comparative example in each of which an all-solid-state battery was produced will be described.

### Example

### Production of Solid Electrolyte

A Li₂S powder and a P₂S₅ powder, which were sulfides, were mechanically milled together to produce a solid electrolyte.

Concretely, in an argon gas atmosphere, a Li₂S powder and a P₂S₅ powder were weighed in such a manner that the molar ratio of the Li₂S powder to the P₂S₅ powder became 80:20 and the powders were placed in an alumina container. Alumina balls each having a diameter of 10 mm were introduced into the container, and the container was hermetically sealed. The container was set on a mechanical milling apparatus (a Fritsch planetary ball mill, model P-7) and then subjected to a mechanical milling treatment at a rotating speed of 370 rpm for 20 hours. Subsequently, the container was opened in an argon gas atmosphere, toluene (2 ml) was introduced into the container, and then the container was hermetically sealed. The mechanical milling treatment was further carried out at a rotating speed of 200 rpm for 2 hours. A slurry-like material thus produced was filtrated in an argon gas atmosphere and then dried in vacuo to produce a powder. The powder was used as a glass powder for a positive electrode mixture.

The powder thus produced was heated at a temperature of 200 to 300° C. in a vacuum atmosphere to produce a glass ceramic powder. The glass ceramic powder was used in a solid electrolyte layer.

<Production of Positive Electrode Active Material>

FeSO₄.7H₂O was dissolved in pure water to produce an aqueous solution, and then H₃PO₄ (a 85% aqueous solution) that served as a P source and H₂O₂ (a 30% aqueous solution) that served as an oxidizing agent were added to the aqueous solution to produce a mixed aqueous solution. In this procedure, FeSO₄.7H₂O, H₃PO₄ and H₂O₂ were added in such a manner that the molar ratio among these compounds became 1:1:1.5.

Subsequently, pure water was added to acetic acid to produce an aqueous solution, and then ammonium acetate was dissolved in the aqueous solution to produce a buffer solution. The molar ratio of acetic acid to ammonium acetate was 1:1, and the concentration of each of acetic acid and ammonium acetate was 0.5 mol/L. When the pH value of the buffer solution was measured, it was 4.6.

The mixed aqueous solution was added dropwise to the buffer solution while stirring the buffer solution at ambient temperature, thereby producing a precipitated powder. The pH value of the buffer solution was decreased with the increase in the amount of the mixed aqueous solution to be added dropwise, and the dropwise addition of the mixed aqueous solution to the buffer solution was terminated when the pH value of the buffer solution became 2.0.

Subsequently, the resultant precipitated powder was filtrated, then washed with a large volume of water, then heated to a temperature of 120° C. and then dried, thereby producing a brown FePO₄.nH₂O powder.

Subsequently, the FePO₄.nH₂O powder was mixed with CH₃COOLi.2H₂O (lithium acetate dihydrate) at a molar ratio of 1:1, and pure water and a polycarboxylic acid-type polymeric dispersant were added to the resultant mixture. Gas-phase carbon fiber manufactured by Showa Denko K.K. (trade name: VGCF, registered trade name: VGCF, referred to as “VGCF” hereinbelow) was further added to the mixture in such a manner that the amount of VGCF became 15 parts by weight relative to 100 parts by weight of LiFePO₄, and the resultant mixture was agitated and pulverized using a ball mill, thereby producing a slurry. The slurry was dried using a spray drier, then granulated, and then thermally treated at a temperature of 700° C. for 5 hours in a H₂—N₂ mixed gas which was adjusted to a reductive atmosphere having an oxygen partial pressure of 10⁻²⁰ MPa, thereby producing a positive electrode active material (lithium iron phosphate: LiFePO₄) containing fibrous carbon (VGCF).

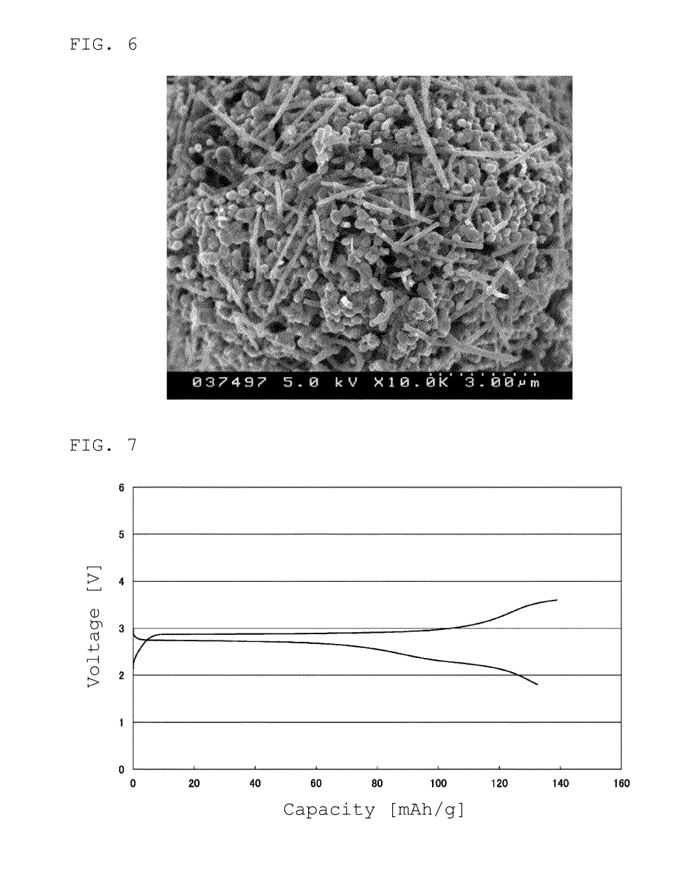

The positive electrode active material containing the fibrous carbon thus produced was observed on a scanning electron microscope (SEM). Photographs obtained in the observation are shown in FIG. 4 (at a high magnification), FIG. 5 (at a low magnification) and FIG. 6 (at a medium magnification). FIG. 4 demonstrates that a complex in which the positive electrode active material is bound to the fibrous carbon is formed. FIG. 5 and FIG. 6 demonstrate that secondary particles (complex granules) each formed of the positive electrode active material and the fibrous carbon are formed.

<Production of Positive Electrode Mixture>

In an argon gas atmosphere, the glass powder which had been produced in the above-mentioned step of producing the solid electrolyte and the positive electrode active material containing fibrous carbon which had been produced in the above-mentioned procedure were weighed in such a manner that the ratio of the amount of the glass powder to the amount of the positive electrode active material became 57:33 by weight, and then mixed together using a rocking mill for 1 hour, whereby a positive electrode mixture was produced.

The resultant positive electrode mixture (200 mg) was introduced into a mold having a diameter of 10 mm, and then press-molded at a pressure of 329 MPa, thereby producing a molded article. The resultant molded article was placed on a carbon crucible and heated in a vacuum atmosphere at a temperature of 200° C. for 6 hours. The heated molded article was pulverized in a mortar, thereby producing a positive electrode mixture.

<Production of all-Solid-State Battery>

The glass ceramic powder (150 mg) which had been produced in the above-mentioned solid electrolyte production step was placed in a die made from polyethylene terephthalate (PET) and having an inner diameter of 10 mm, and then press-molded at a pressure of 110 MPa, thereby producing a solid electrolyte layer.

The positive electrode mixture (10 mg) which had been produced in the above-mentioned procedure was introduced through one side of the die, In—Li which served as a negative electrode material was introduced from the other side of the die, a stainless steel sheet was arranged on either side, and then the resultant product was press-molded at a pressure of 329 MPa, thereby producing a laminate which served as a battery element of an all-solid-state battery. The laminate was sealed in a laminate container, thereby producing an all-solid-state battery.

<Evaluation of Battery Properties>

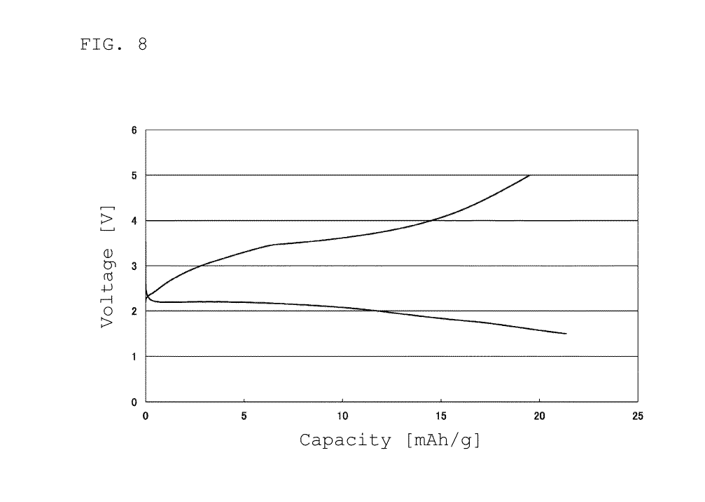

The all-solid-state battery which had been produced in the above-mentioned procedure was charged and discharged at a constant current of 10 μA (current density: 12.7 μA/cm²) at a voltage of 3.6 to 1.8 V. When the charge-discharge cycle was repeated at a temperature of 50° C. and the discharge capacity was measured when the capacity was not changed any more, the discharge capacity was 135 mAh/g. A charge-discharge curve obtained in this experiment is shown in FIG. 7. In the charge-discharge curve, a flat area was observed around a voltage of 2.8 V, and it was therefore confirmed that the charging-discharging proceeded reversibly.

The above-mentioned results of the example demonstrate that, when fibrous carbon is bound to a positive electrode active material, electron supply paths to the positive electrode active material can be formed satisfactorily, and it becomes possible to produce a chargeable-dischargeable battery even when lithium iron phosphate which has poor electron conductivity is used as the positive electrode active material. Particularly, the above-mentioned value of the discharge capacity is close to the value of the theoretical capacity of lithium iron phosphate, and it is found that almost the whole of lithium iron phosphate existing in the positive electrode mixture is involved in the charging and discharging of the battery. Furthermore, it is also found that both lithium ion supply paths and electron supply paths can be formed satisfactorily and therefore a battery having a large capacity can be produced by mixing a solid electrolyte with a positive electrode active material containing fibrous carbon, molding the mixture, and heating the molded product.

### Comparative Example

### Production of Solid Electrolyte

A solid electrolyte was produced in the same manner as in the example.

<Production of Positive Electrode Active Material>

A positive electrode active material which did not contain fibrous carbon was produced in the same manner as in the example, except that fibrous carbon was added in the process.

<Production of Positive Electrode Mixture>

In an argon gas atmosphere, the glass powder which had been produced in the above-mentioned solid electrolyte production step and the positive electrode active material containing no fibrous carbon which had been produced in the above-mentioned procedure were weighed in such a manner that the ratio of the amount of the glass powder to the amount of the positive electrode active material became 57:33 by weight, and then mixed together using a rocking mill for 1 hour. The resultant mixture and the above-mentioned VGCF were weighed in such a manner that the ratio of the amount of the mixture to the amount of the VGCF became 90:10 by weight, and then mixed together using a rocking mill for 1 hour, thereby producing a positive electrode mixture.

<Production of all-Solid-State Battery>

An all-solid-state battery was produced in the same manner as in the example.

<Evaluation of Battery Properties>

The all-solid-state battery which had been produced in the above-mentioned procedure was charged and discharged at a constant current of 10 μA (current density: 12.7 μA/cm²) at a voltage of 3.6 to 1.8 V. However, the resistivity of the battery was high and the battery could not be charged or discharged. Then, the battery was charged and discharged at a constant current wherein the current value of the constant current was decreased and the range of the voltage during charging and discharging was expanded. Concretely, the charging and discharging was carried out at a constant current of 1 μA (current density: 1.3 μA/cm²) at a voltage of 5 to 1.5 V. A charge-discharge curve produced in this experiment is shown in FIG. 8. As illustrated in FIG. 8, although a charging-discharging behavior was observed, it was found that the current flowed at a voltage that is different from the charging-discharging voltage of lithium iron phosphate. This behavior is a charging-discharging behavior caused by a side reaction, and it is found that lithium iron phosphate in the battery is not involved in the charging-discharging behavior of the battery.

The results of the comparative example as mentioned above demonstrate that a sulfide solid-state battery using lithium iron phosphate as a positive electrode active material cannot be charged or discharged merely by adding VGCF as a conductive additive.

It should be understood that the embodiments and examples disclosed herein are illustrative only and not restrictive in all respects. The scope of the present invention is defined by the appended claims rather than the foregoing embodiments and examples, and all changes and modifications that fall within the equivalent meaning and scope of the claims are intended to be included within the scope of the present invention.

According to the present invention, a high-capacity secondary battery can be produced.

### DESCRIPTION OF REFERENCE SYMBOLS

10 all-solid-state battery
11 positive electrode layer
12 negative electrode layer
13 solid electrolyte layer.

1. A positive electrode material comprising:
a positive electrode active material; and
fibrous carbon bound to the positive electrode active material.

2. The positive electrode material according to claim 1, wherein the positive electrode active material comprises a lithium composite oxide having a polyanion structure represented by LiₐMₘXO_{b}F_{c}, wherein
M is at least one transition metal,
X is at least one element selected from the group consisting of B, Al, Si, P, Cl, Ti, V, Cr, Mo and W,
0<a≦3,
0<m≦2,
2≦b≦4, and
0≦c≦1.

3. The positive electrode material according to claim 2, wherein the lithium composite oxide is a phosphate compound.

4. The positive electrode material according to claim 3, wherein the phosphate compound is lithium iron phosphate.

5. The positive electrode material according to claim 1, wherein the fibrous carbon is bound to the positive electrode active material by a secondary particle composed of a complex of the positive electrode active material and the fibrous carbon.

6. A secondary battery comprising:
a positive electrode layer comprising the positive electrode material according to claim 1;
a negative electrode layer; and
an electrolyte layer interposed between the positive electrode layer and the negative electrode layer.

7. The secondary battery according to claim 5, wherein the positive electrode active material comprises a lithium composite oxide having a polyanion structure represented by LiₐMₘXO_{b}F_{c}, wherein
M is at least one transition metal,
X is at least one element selected from the group consisting of B, Al, Si, P, Cl, Ti, V, Cr, Mo and W,
0<a≦3,
0<m≦2,
2≦b≦4, and
0≦c≦1.

8. The secondary battery according to claim 7, wherein the lithium composite oxide is a phosphate compound.

9. The secondary battery according to claim 8, wherein the phosphate compound is lithium iron phosphate.

10. The secondary battery according to claim 6, wherein the fibrous carbon is bound to the positive electrode active material by a secondary particle composed of a complex of the positive electrode active material and the fibrous carbon.

11. The secondary battery according to claim 6, wherein the positive electrode layer comprises a solid electrolyte, and wherein the secondary battery is an all-solid-state battery.

12. The secondary battery according to claim 11, wherein the solid electrolyte is a sulfide solid electrolyte.

13. The positive electrode material according to claim 12, wherein the fibrous carbon is bound to the positive electrode active material by a secondary particle composed of a complex of the sulfide solid electrolyte, the positive electrode active material and the fibrous carbon.

14. The positive electrode material according to claim 6, wherein the fibrous carbon is bound to the positive electrode active material by a secondary particle composed of a complex of the electrolyte, the positive electrode active material and the fibrous carbon.

15. A method for producing the positive electrode material of claim 1, the method comprising:
mixing the positive electrode active material with the fibrous carbon to produce a mixture; and
heating the mixture.

16. A method for producing the secondary battery as recited in claim 11, the method comprising:
mixing the positive electrode active material with the fibrous carbon to produce a first mixture;
heating the first mixture;
mixing the first mixture with the solid electrolyte to produce a second mixture; and
producing a first molded article from the second mixture.

17. The method according to claim 16, the method further comprising:
heating the first molded article;
pulverizing the heated first molded article to produce a pulverized material; and
producing a second molded article from the pulverized material.
